(19) United States
(12) Patent Application Publication
(10) Pub. No.: US 2015/0069247 A1
(43) Pub. Date: Mar. 12, 2015

(54) METHOD AND SYSTEM FOR REAL TIME INSPECTION OF A SILICON WAFER

(71) Applicant: NANYANG TECHNOLOGICAL UNIVERSITY, Singapore (SG)

(72) Inventors: Anand Krishna Asundi, Singapore (SG); Chi Seng Ng, Singapore (SG)

(73) Assignee: NANYANG TECHNOLOGIAL UNIVERSITY, Singapore (SG)

(21) Appl. No.: 14/394,616

(22) PCT Filed: Apr. 14, 2013
(86) PCT No.: PCT/SG13/00148

§ 371 Date: Oct. 15, 2014

Related U.S. Application Data
(60) Provisional application No. 61/625,355, filed on Apr. 17, 2012.

(51) Int. Cl. G01N 21/95; G01N 21/88

(52) U.S. Cl. CPC G01N 21/9501; G01N 21/8806; G01N 2021/8848; G01N 2201/062; G01N 2201/125
USPC 250/341.3; 250/338.1

(57) ABSTRACT

There is provided a method and system for real time inspection of a silicon wafer. The method includes using an infrared plane polariscope to obtain an image of a bonded interface of the silicon wafer, the image showing stress patterns; and assessment of the stress patterns. The stress patterns in a form of at least one butterfly pattern indicates a presence of at least one of: at least one trapped particle, trapped gases and at least one de-bonding region. No computer/algorithm processing is carried out to locate defects/de-bondings at the bonded interface. Furthermore, the stress fields being generated can be used to approximate the size of the de-bonding region/trapped particle. The system employs the infrared plane polariscope to obtain an image of a bonded interface of the silicon wafer.

### FIELD OF INVENTION

The present invention relates to a method and system for inspecting a bonded interface of a silicon wafer.

### BACKGROUND

For decades, mechanical and optical approaches have been employed for experimental stress analysis of a structure. With regard to a mechanical approach, a strain gauge is typically employed as a sensor to determine strain induced within an object when subjected to a load. A strain gauge is able to rapidly provide accurate information about the strain readings. However, it needs to be in contact with the object for measurement and the measurement points are limited by the number of strain gauges being used. Consequently, full field strain visualization is not possible.

Ultrasonic microscopy/Scanning Acoustic Microscopy (SAM) extracts the residual stress by measuring acoustic impedance obtained from the propagation of acoustic waves with changes of wave speed in a medium under different stresses. This method provides satisfactory results only when the material is uniform in microstructure and composition. An example of such a material is silicon. However, this method is time consuming and not suitable for real time manufacturing process measurement and monitoring. Furthermore, non-homogeneity in a material results in inaccurate stress prediction. As such, defects/de-bonding due to trapped particles at a bonded interface may not be correctly identified.

Photoelastic methods which have demonstrated some potential have been adapted for full-field stress analysis. Photoelastic methods are one of the oldest but potentially useful experimental methods for analyzing stress or strain in engineering mechanics applications. In photoelastic methods, a polariscope (an instrument based on the fundamentals of photoelasticity which utilize polarized light to obtain the stress state in a loaded birefringent material) is typically utilised. There are two types of polariscope that are frequently employed—a plane polariscope 20 (FIG. 1) and a circular polariscope 40 (FIG. 2). The plane polarizer 20 consists of two linear polarizers 22, 24, namely a polarizer 22 and an analyzer 24. The circular polariscope 40 consists of additional two quarter-waveplates 26(a), 26(b) in between the plane polarizer 20 setup.

With regard to the inspection of trapped particles at the bonded interface of silicon wafer, conventional Infrared Transmission (IRT) techniques have been widely employed in manufacturing industries such as, for example, semiconductor, MEMS, photovoltaic and the like. An inspection setup using IRT is shown in FIG. 3. Silicon based devices is translucent to electromagnetic wavelength of approximately 1150 nm. Newton's rings are used to identify the defect/de-bonding region attributed to trapped particles. FIG. 7 shows an IRT image of a bonded silicon wafer. The magnitude of the stress/defect is evaluated depending on the size of the Newton's rings. A region without visible Newton's rings will be considered defect free. The trend of miniaturization of the silicon based devices has made IRT techniques increasingly ineffective for defects and trapped particles inspection as the miniaturization of silicon based devices leads to Newton's rings becoming less visible (or not generated at all) because of smaller particles trapped at the interface of bonded silicon wafer. The trapped particles are too small to generate a complete Newton's Ring. Moreover, these particles generate high stress at the bonded interface. If there is a defect due to trapped particles or gasses, the stress field generated is expected to look like butterfly patterns when the specimen is visualized using an infrared polariscope. Furthermore, infrared cameras typically capture images with pixel sizes ranging from 25 μm to 30 μm. Any defects or trapped particles smaller than the aforementioned pixel sizes become “invisible” (that is, the issue of defects/trapped particles cannot be resolved).

Consequently, grey field polariscopes were developed to compensate the shortcomings of conventional IRT techniques. Grey field polariscopes are an evolution of circular polariscopes. Grey field polariscopes have been developed for full field photoelastic stress analysis. Grey field photoelasticity was pioneered by Jon Lesniak at Stress Photonics to provide visible full field birefringence measurement in glass components. Successful implementation in the glass industry has led to use in silicon substrate applications using similar setups with halogen illumination sources that transmit near Infrared wavelength. The grey field polariscope 50 illustrated in FIG. 4 consists of the polarizer 22, the analyzer 24 and a single quarter waveplate 26(c).

Photoelastic methods and grey field polariscopes have been used to detect de-bonding caused by trapped particles/gases using the generated stress pattern. Multiple images at different orientations of analyzer 24 are captured and computer processing is required to generate a shear stress image. Subsequently, a ‘buttery’ shaped stress pattern generated due defect/de-bonding is readily identifiable in the processed residual stress image. However, even though IR-GFP techniques enable high sensitivity inspection, it is typically not desirable for a manufacturer to adopt such inspection techniques which do not provide results in real time.

It is evident that there are issues in the aforementioned inspection techniques.

### SUMMARY

In a first aspect, there is provided a method for real time inspection of a silicon wafer. The method includes using an infrared plane polariscope to obtain an image of a bonded interface of the silicon wafer, the image showing stress patterns; and assessment of the stress patterns. The stress patterns in a form of at least one butterfly pattern indicates a presence of at least one of: at least one trapped particle, trapped gases and at least one de-bonding region. No computer/algorithm processing is carried out to locate defects/de-bondings at the bonded interface. Furthermore, the stress fields being generated can be used to approximate the size of the de-bonding region/trapped particle.

The size of the at least one butterfly pattern is typically larger than a size of the at least one of: at least one trapped particle, trapped gases and at least one de-bonding region. The size of the stress patterns is proportional to a size of the at least one of: at least one trapped particle, trapped gases and at least one de-bonding region.

The method may further include rotating at least one of an analyzer and a polarizer of the infrared plane polariscope to carry out phase shifting. The rotation of the at least one of the analyzer and the polarizer is carried out respectively either by manual rotation or using an actuator. The phase shifting is carried out to investigate isoclinics and phase retardation. The magnitude and direction of stress generated by the at least one of: at least one trapped particle, trapped gases and de-bonding region is obtainable from the investigation of isoclinics and phase retardation.

Assessing of the stress patterns may be carried out using known image processing software and hardware. The use of known image processing software and hardware is employed during instances of poor lighting conditions.

Finally, a level of intensity of light emerging from the analyzer correlates to stress generated by the at least one of: at least one trapped particle, trapped gases and at least one de-bonding region.

In a second aspect, there is provided a system for real time inspection of a silicon wafer using an infrared plane polariscope to obtain an image of a bonded interface of the silicon wafer.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows an arrangement of optical elements in a plane polariscope (prior art).

FIG. 2 shows an arrangement of optical elements in a circular polariscope (prior art).

FIG. 3 shows an inspection setup using IRT (prior art).

FIG. 4 shows an arrangement of optical elements in a grey field polariscope (prior art).

FIG. 5 shows an arrangement of optical elements in a reflection polariscope of the present invention.

FIG. 6 shows an arrangement of optical elements in a transmission polariscope of the present invention.

FIG. 7 shows an IRT image of a bonded silicon wafer.

FIG. 8 shows four phase shifted images of bonded silicon wafer using a grey field polariscope.

FIG. 9 shows residual stress images of the phase shifted images of FIG. 8.

FIG. 10 shows an image of particles trapped at a glass silicon interface.

FIG. 11 shows an image of stress patterns for the trapped particles of FIG. 10.

FIG. 12 shows an image of a bonded wafer where Newton's rings are visible but not the trapped particle.

FIG. 13 shows an image of the bonded wafer of FIG. 12 using a transmission polariscope of the present invention.

FIG. 14 shows an isoclinic image of the bonded wafer of FIG. 12.

FIG. 15 shows a phase retardation image of the bonded wafer of FIG. 12.

FIG. 16 shows an infra-red plane polariscope image of a trapped particle.

FIG. 17 shows a shape of the trapped particle of FIG. 16 under reflection microscopy.

FIG. 18 shows a stress pattern due to the trapped particle of FIG. 16 under reflection plane polariscope microscopy.

FIG. 19 shows images of trapped particles/de-bonding area and the corresponding stress pattern at a different region under both reflection microscopy and reflection plane polariscope microscopy.

FIG. 20 shows a plot of the table of data shown in FIG. 24.

FIG. 21 shows the visibility of a butterfly pattern with different polarization axis of cross polarizers.

FIG. 22 shows stress pattern images using different light sources.

FIG. 23 shows a table of intensity equations for various combinations of α and β.

FIG. 24 shows a table of corresponding de-bonding radius and stress pattern sizes due to trapped particles.

FIG. 25 shows a process flow for the method of the present invention.

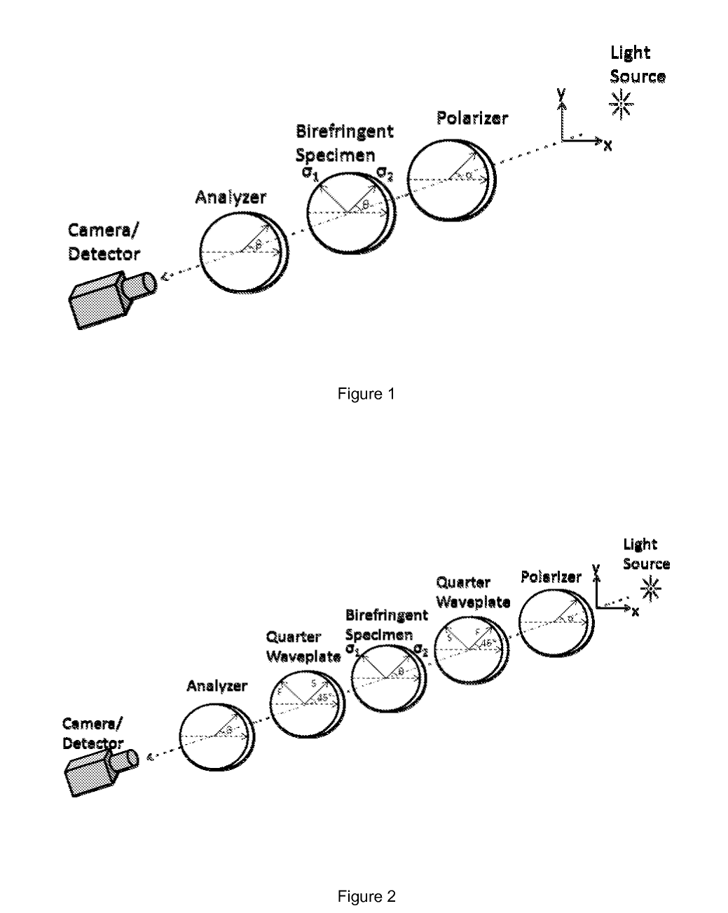

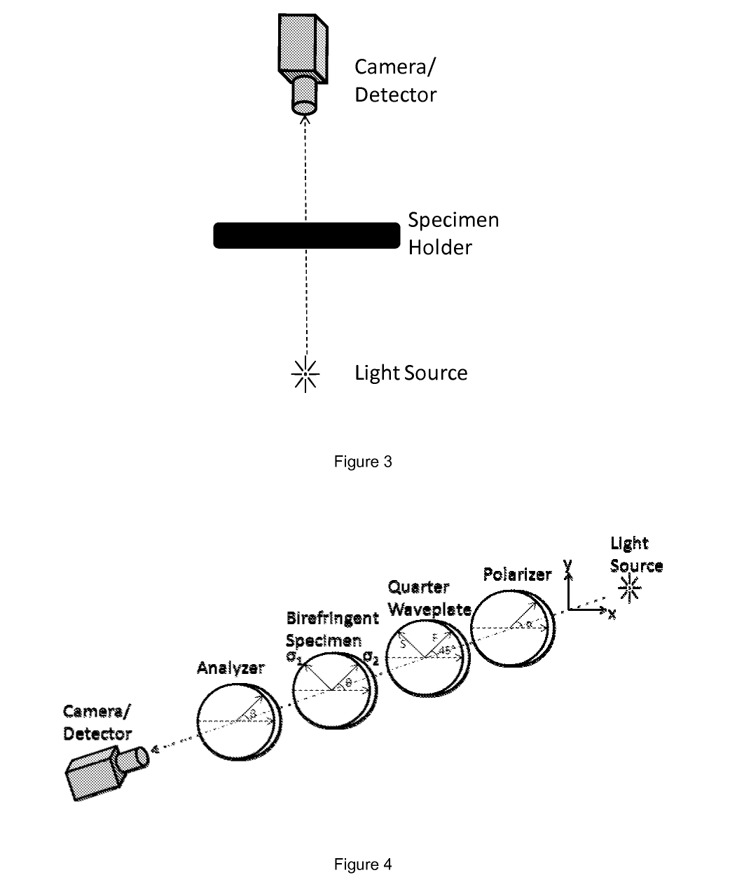

### DESCRIPTION OF PREFERRED EMBODIMENTS

The present invention provides a method and system for carrying out fast real time inspections for a bonded interface of a silicon wafer pair (with defect/de-bonding due to trapped particles/gases) using an infrared plane polariscope (IR-PP). The method employs the fundamentals of photoelasticity together with unique arrangements for the optical components being used. The stress fields generated by trapped particles/gases are used to locate defect positions. Moreover, the method also provides a photoelastic stress analysis to determine direction of shear stress for birefringent materials. No computer/algorithm processing is carried out to locate defects/de-bondings at the bonded interface. Furthermore, the stress fields being generated can be used to approximate the size of the de-bonding area/trapped particle. It should be appreciated that the present invention is suitable for use with both glass-silicon bonded wafer inspection and silicon-silicon bonded wafer inspection. The present invention may also be usable with other forms of birefringent materials.

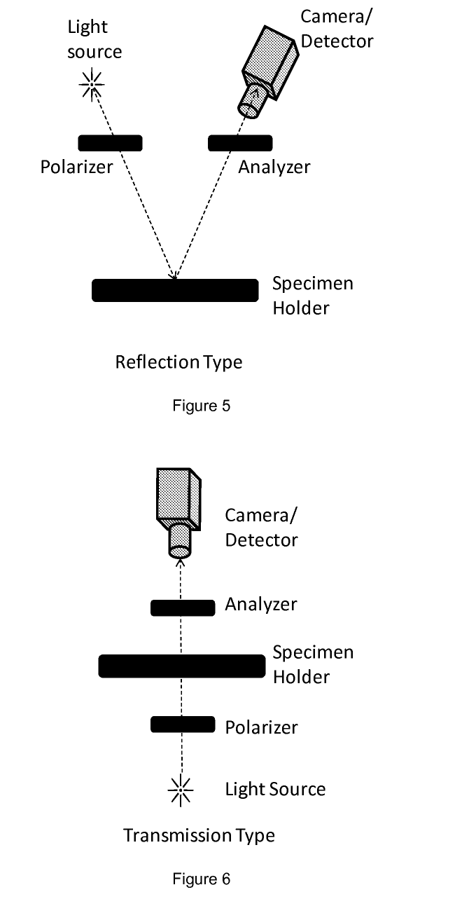

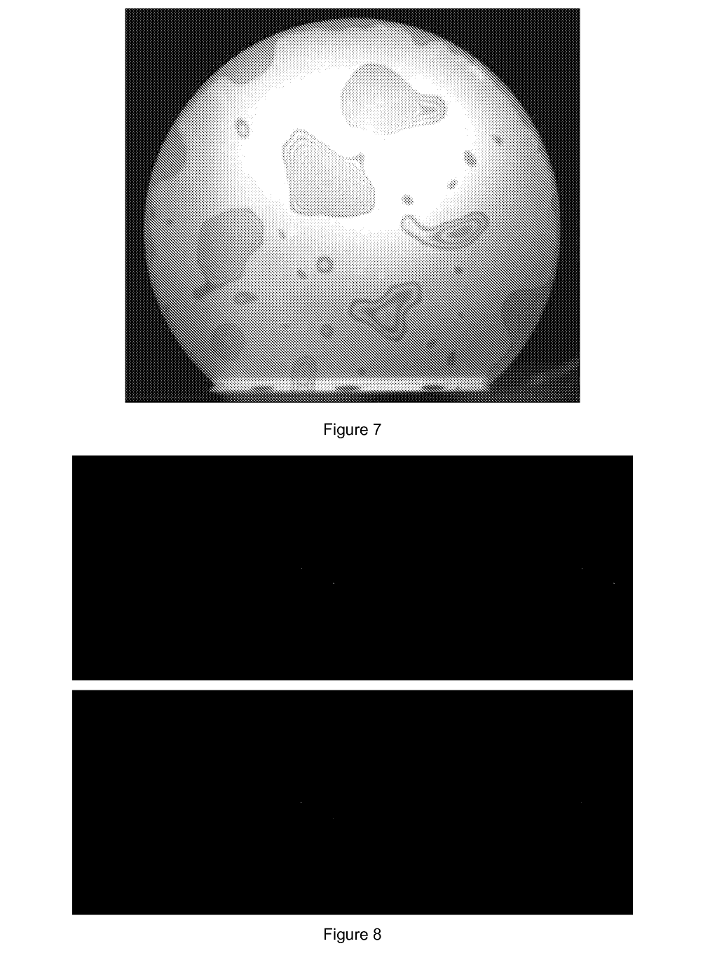

There are two optical arrangements for a system of the present invention. The first optical arrangement illustrated in FIG. 5 is a reflection type plane polariscope arrangement 60. The second optical arrangement illustrated in FIG. 6 is a transmission type plane polariscope arrangement 70. The first optical arrangement (reflection type) can be used in a glass-Si bonded wafer where visible light can be transmitted through the glass layer to the bonded interface. A light source 62 used in the arrangements 60, 70 can be either near-infrared or visible. Visible sources are mainly for glass-Si bonded wafers while near-infrared sources are for Si—Si wafers. Both optical arrangements 60, 70 have similar sensitivity. The near infrared or visible light source 62, with wavelength greater than 1150 nm, is used to provide illumination for a birefringent sample. A first linear polarizer near the light source is termed polarizer 64 (to obtain plane polarized light) and the second linear polarizer near the detector is termed analyzer 66 (to analyze stress information from light emerging from the birefringent sample). A level of intensity of the light emerging from the analyzer 66 correlates to stress generated by, for example, at least one trapped particle, trapped gases, a de-bonding region and so forth. The correlation between the level of intensity of the light and the generated stress can be derived using Jones calculus and will be described in further detail in subsequent paragraphs, specifically in equations 1 and 2. Thus, it is appreciated that the generated stress can be obtained/predicted as long as the requisite parameters are provided. There is also a near infrared camera 67 (for example, indium gallium arsenide (InGaAs) Camera) for capturing short wavelength infrared (SWIR)/near infrared (NIR) images, and to record/visualize intensity images emerging from the analyzer 66.

The arrangements 60, 70 are used to visualize full-field phase retardation superposed with principle stress direction of defect/trapped particles at bonded interface of the birefringent materials in real time. The arrangements 60, 70 do away with the use of quarter-waveplates. Consequently, the errors introduced by quarter waveplates in measurement can be reduced. The placement of a specimen under test should not introduce additional stress to the specimen (of a birefringent material). The present invention may employ a vertical setup configuration, whereby the specimen under test can rest on a flat surface without a need for clamping. In a horizontal system setup configuration, clamping of specimen is needed to hold the specimen in position during measurement, consequently introducing additional stress around the clamping area. Clamping forces exerted on extremely thin specimens might result in damage around the clamping edge and changes in local stresses.

Using either of the aforementioned setups 60, 70, the Infrared Plane Polariscope (IR-PP) is developed to provide real time and high resolution defects inspection at a bonded interface of silicon wafer. The use of the IR-PP allows stress patterns generated by trapped particles to be observed and assessed in real time without using computer/algorithm processing. The IR-PP does not require a quarter waveplate yet is still able to provide desirable sensitivity and measurement speed characteristics. Furthermore, doing away with a quarter waveplate minimises alignment issues for the IR-PP and consequently reduces errors caused by the mis-alignment of the quarter waveplate. Moreover, it is also possible to obtain quantitative data by using phase shift techniques whereby the intensity data from three or more different phases are recorded.

For typical plane polariscopes, the axes of polarization are perpendicular to each other. Such polariscopes are described as dark field polariscopes, whereby the intensity is zero if no loaded birefringent material exists between them. In plane polariscopes, polarized light is incident onto the polarizer 64. The incident light will emerge from the polarizer 64 as plane polarized light along a polarization axis of the polarizer 64. Since the polarization axes are crossed, no light can be seen passing from the analyzer 66 if no birefringent material is positioned in the path of the incident light. When stressed birefringent material is located in between the polarizer 64 and the analyzer 66, upon entering the birefringent material, the single polarized light ray will split into two perpendicular light components, namely the ordinary and the extra-ordinary. These polarized light components travel a same distance through the thickness of material with different speed and optical path lengths because each is affected by a refractive index of the birefringent material. Thus, when a birefringent material is placed within the dark field plane polariscope, the birefringent material splits the polarized light into two perpendicular polarized light components, whereby a first component will travel along a fast axis while a second component will travel along a slow axis but along the same direction. The first component which travels along the fast axis is equal to S₁, while the second component which travels along the slow axis is equal to S₂. When the first and second components emerge from the material, there exists a relative phase difference, called the relative retardation, which contribute to the formation of fringes. The first and second components as seen from the analyzer 66 are actually the components that travel parallel to the polarization axis of analyzer 66.

By using Jones calculus, for a plane polariscope, keeping polarizer 64 at arbitrary angle α and analyzer 66 at arbitrary angle β, the intensity of the light transmitted through analyzer 66 can be described using the following equation:

I=a²[cos²(δ/2)cos²(β−α)+sin²(δ/2)cos²(β+α−2θ) (1)

I is the intensity of light at the region of interest.
a is the amplitude of the source.
α is the orientation of polarization axis of polarizer 64.
β is the orientation of polarization axis of analyzer 66.
θ is the angle between the polarization axis of polarizer 64 and direction of principle stress/isoclinics.
δ is the principle stress difference due to birefringence in the specimen/isochromatics.

In the present invention, for real time inspection, dark field plane polariscope configuration is adopted. α is set at 90° and 6 is set at 0° and equation 1 reduces to:

I=a²[sin²(δ/2)sin²2 θ] (2)

I is the intensity of light at the region of interest.
a is the amplitude of the source.
θ is the angle between the polarization axis of polarizer 64 and direction of principle stress/isoclinics.
δ is the principle stress difference due to birefringence in the specimen/retardation.

From equation 2, retardation and isoclinics are superposed on one another. This is referred to as isoclinics and retardation interaction. This phenomenon becomes an added advantage for the detection of trapped particles of this invention.

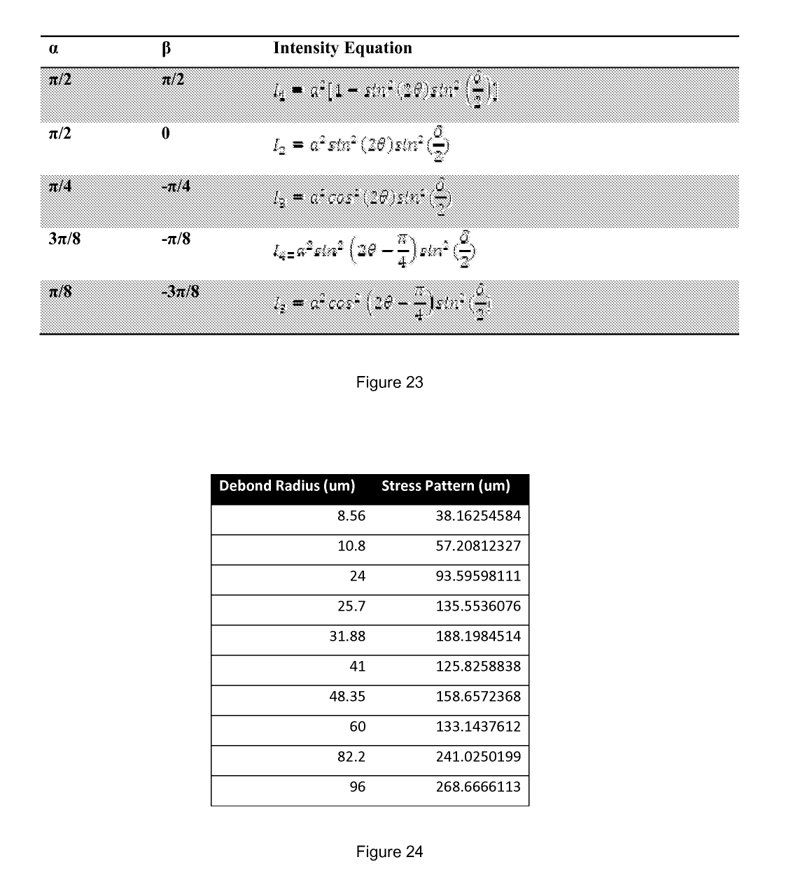

In the present invention, the intensity image contains phase information that is affected by both direction of principle stress and principle stress difference. To access the individual stress parameters, phase shifting technique can be employed. Phase shifting is achieved by rotation of at least one of the polarizer 64 and the analyzer 66 using predetermined steps. Multiple intensity images are captured by rotating the optical elements in known steps to obtain a set of intensity equations. Each of the intensity images contains phase information changes for every state of the polarizer 64 and the analyzer 66. With sufficient amount of phase shifted images, parameters that contain the phase information can be calculated using one of several known algorithms. In this invention, for illustrative purposes, Buckberry and Towers's algorithm is the known algorithm which is employed. In this algorithm, one bright field and four dark field arrangements are needed as shown in the following example. The intensity equations for various combinations of α and β are listed in FIG. 23. θ is the angle between the polarization axis of polarizer and direction of fast axis. δ is the principle stress difference due to birefringence in the specimen. From the five intensity equations in FIG. 23, δ and θ are derived to be

θ=1/4 tan⁻¹(I₄−I₅)/(I₃−I₂) (3)

δ=cos⁻¹[I₁+I₂−2(I₃+I₂)]/(I₁+I₂) (4)

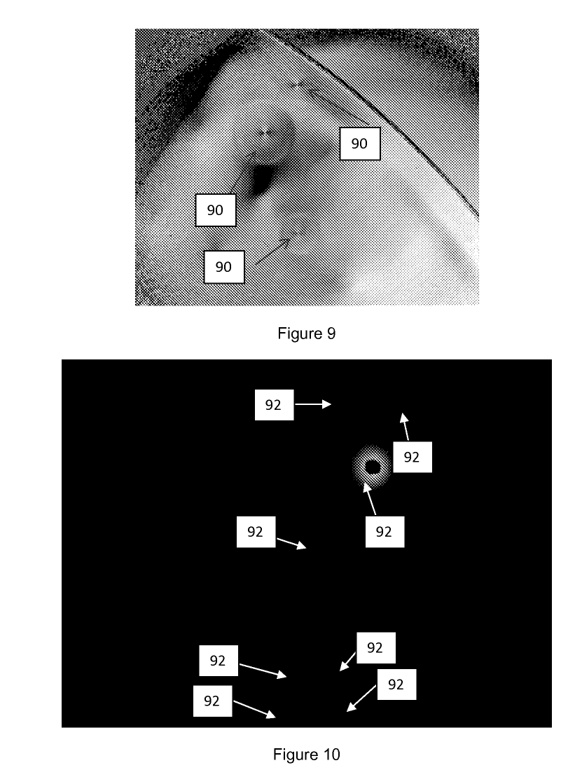

Referring to FIG. 8, there is shown four phase shifted images of bonded silicon wafer using a grey field polariscope. Trapped particles are difficult to locate in the polarized phase shifted images. The only notable difference in these images relates to the slight changes in intensity. However, the changes in intensity are not necessarily due to trapped particles or gases, and may due to contamination at the interface surfaces. Contamination does not generate stress on the specimen. As such, by using Photoelastic methods, defects at bonded interfaces can be differentiated from contamination. FIG. 9 shows the corresponding residual stress image of the phase shifted images illustrated in FIG. 8. Butterfly patterns are visible at the location of trapped particles and are indicated using arrows 90.

The butterfly patterns can be viewed directly from residual stress images like FIG. 9. No additional computer/algorithm processing is needed. However, it should be appreciated that in instances of poor lighting conditions when direct viewing of the residual stress images is compromised, the residual stress images may be assessed using known image processing software and hardware to identify the butterfly patterns. Thus, the use of the known image processing software and techniques allow the residual stress images to be assessed under any lighting conditions. Even though the use of known image processing software and hardware adds cost and complexity, the lighting conditions under which the residual stress images are assessed may bring about a need for the known image processing software and hardware. For ease of comparison, a sample with glass and silicon bonded interface is selected to take advantage of inspection of particles using visible light reflection microscopy (as shown in FIG. 5). After locating a trapped particle using reflection microscopy, a plane polariscope microscope will be used to visualize the stress pattern originating from the trapped particle to confirm the presence of the trapped particle.

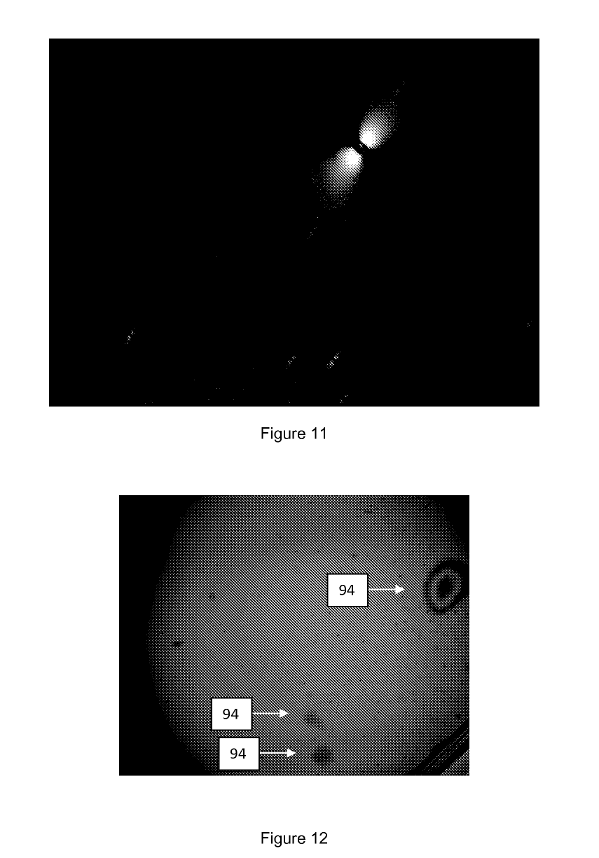

FIG. 10 shows the location of trapped particles which do not generate Newton's rings under high power reflection microscopy. Some of the trapped particles are indicated using arrows 92. FIG. 10 shows that reflection microscopy does provide high sensitivity and good resolution in detecting small trapped particles. Moreover, for some regions, the de-bondings are visible. Furthermore, the scanning area is small and the process is time consuming. Complex scanning technologies are also required. FIG. 11 shows the butterfly stress patterns for the trapped particles identified using reflection plane polariscope microscopy. These stress patterns correspond (match) with the particles identified under reflection microscopy in FIG. 10 under the same magnification. From the butterfly stress patterns in FIG. 11, it can be observed that the trapped particles (in micron size) are able to generate the stress patterns which appear larger than the particle size. Thus, stress field analysis is a visually clearer manner to detect trapped particles. Since the bonded wafer is glass-silicon, all inspections in FIG. 10 and FIG. 11 were carried out in reflection mode using visible light.

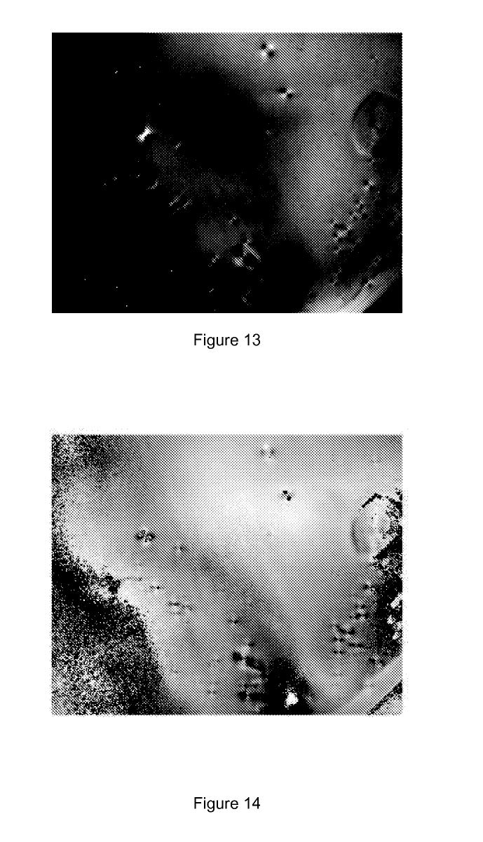

Subsequently, an infrared plane polariscope (IR-PP) is used to perform inspections on bonded wafers via transmission mode (as shown in FIG. 6). In this optical system 70, there is no objective lens attached to the optical system similar to reflection microscopy, and only camera lens with 50 mm focal length is attached to the imaging device. Trapped particles identified in FIG. 10 become invisible under the proposed system. Initially, the bonded specimen is being view using conventional IRT techniques. FIG. 12 shows the state of the bonded wafer where Newton's rings are visible (as indicated using arrows 94) but the small trapped particle is not visible. Furthermore, by using IRT techniques, it is inconclusive whether the lower intensity area is caused by either trapped particles or surface contamination. It can be seen from FIG. 13 that using the transmission optical system 70, all stress patterns due to trapped particles are clearly visualized in real time. Furthermore, the trapped particles and surface contaminations can be differentiated easily. Although the area of inspection is limited by the optical components used in the transmission optical system 70, the area of inspection is much larger compared to the area of inspection using reflection microscopy.

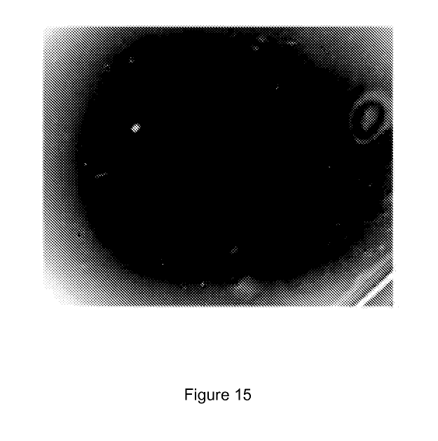

Phase shifting algorithm can be adapted to investigate isoclinics and phase retardation individually. FIG. 14 and FIG. 15 correspond to the isoclinics and phase retardation images respectively. Isoclinics provide contours of the direction of principal stresses across the specimen while the phase retardation is directly proportional to the principal stress difference at any point. Indication of these two values enables quantitative evaluation of the stress field over the entire specimen and more specifically at de-bonding regions and inclusions. By using the phase shifting approach, the stress information can be obtained quantitatively. For sub-fringe analysis, intensity level is proportional to absolute stress magnitude. In addition, the size of the trapped particles or de-bonding areas can also be approximated from the stress pattern.

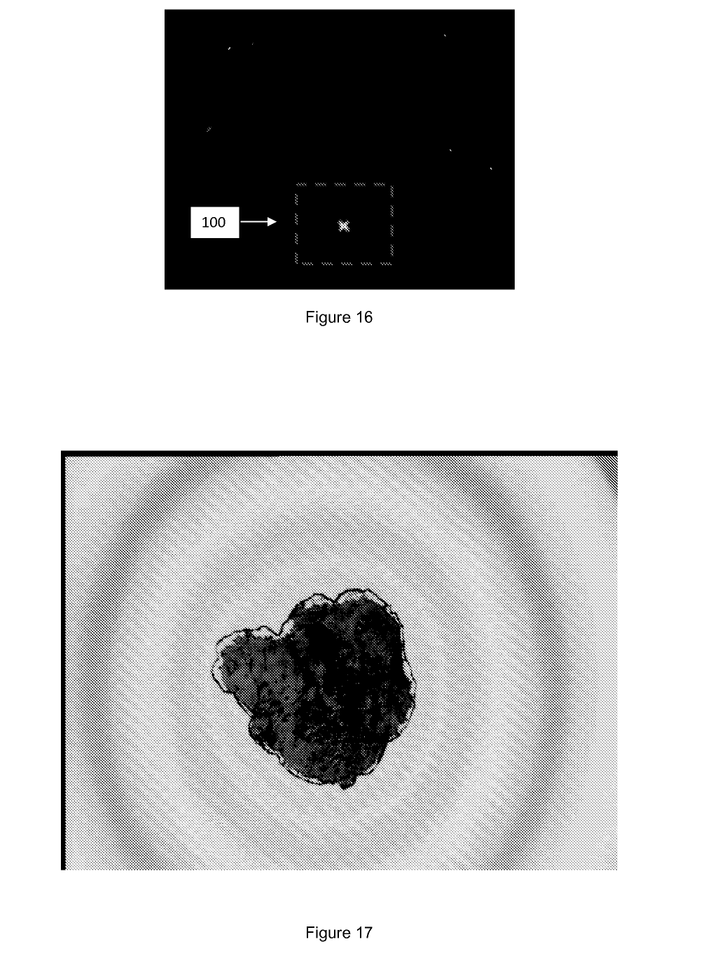

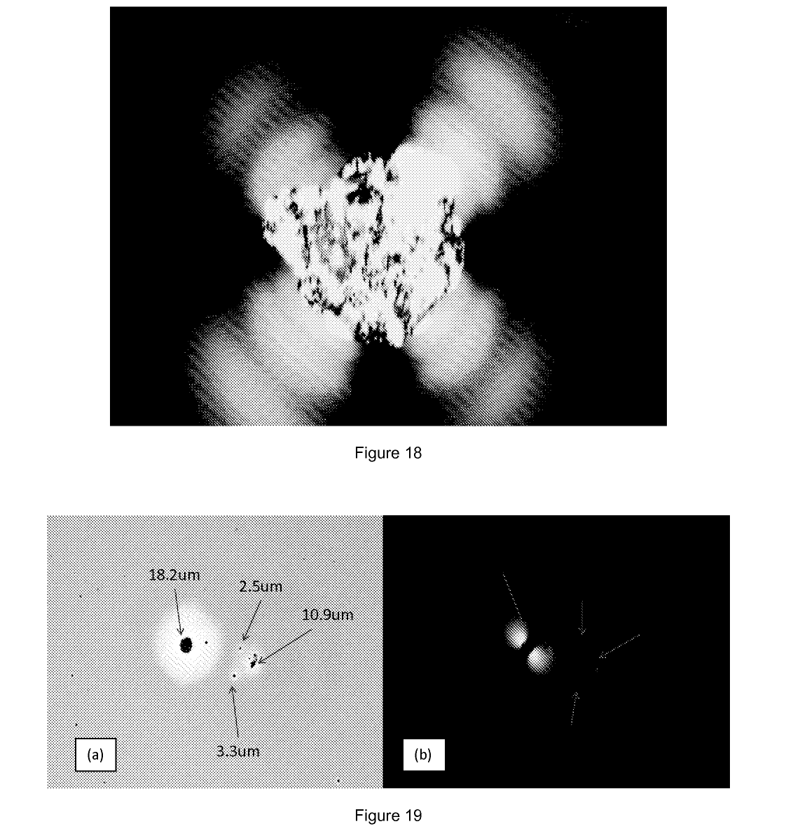

The comparison between trapped particles and stress patterns will now be demonstrated using the reflection type arrangement 60 and the transmission type arrangement 70. Referring to FIG. 16, a large stress pattern (within dotted box 100) is observed in the IR-PP image. The large stress pattern consists of two overlapping butterfly patterns. This stress pattern is further investigated using reflection microscopy to access the shape and stress pattern. Newton's ring due to this trapped particle is hardly visible under reflection microscopy. However, the resulting stress pattern shown in FIG. 16 proves that the trapped particle can be easily detected by IR-PP. FIG. 17 shows the shape of the trapped particle under reflection microscopy. The Newton's ring due to the particle is also visible in the background. Under reflection microscopy, the Newton's ring contrast is improved. FIG. 18 shows the stress pattern due to the trapped particle of FIG. 16 under reflection plane polariscope microscopy, whereby two overlapped butterfly patterns are shown. The particle of FIG. 17 is approximately 200 μm in size, while the corresponding stress pattern is approximately three times the size of the particle.

FIG. 19 shows images of the trapped particles/de-bonding area and the corresponding stress pattern at a different region under both reflection microscopy (FIG. 19(a)) and reflection plane polariscope microscopy (FIG. 19(b)). Particles as small as 2.5 μm in size are found to generate the butterfly pattern. From the images, the size of the de-bonding area is proportional to the size of stress pattern, and the butterfly patterns generated is associated to the de-bonding area caused by the trapped particle. The trapped particle with measured size 10.9 μm generates only one butterfly pattern even though there are a few extremely small particles at its neighbourhood. As such, the size of a de-bonding region also contributes to the existence of butterfly pattern.

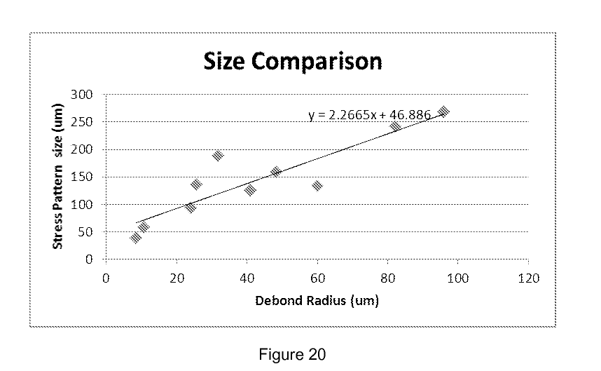

With reference to FIG. 24, there is shown a table of corresponding de-bonding radius and stress pattern sizes due to trapped particles. The size of the stress pattern and de-bonding radius are measured manually whereby no algorithm has been applied for this size measurement. Even though manual measurement typically includes precision issues, the table of FIG. 24 and graph of FIG. 20 clearly illustrates a correlation between the stress pattern sizes and de-bonding radius.

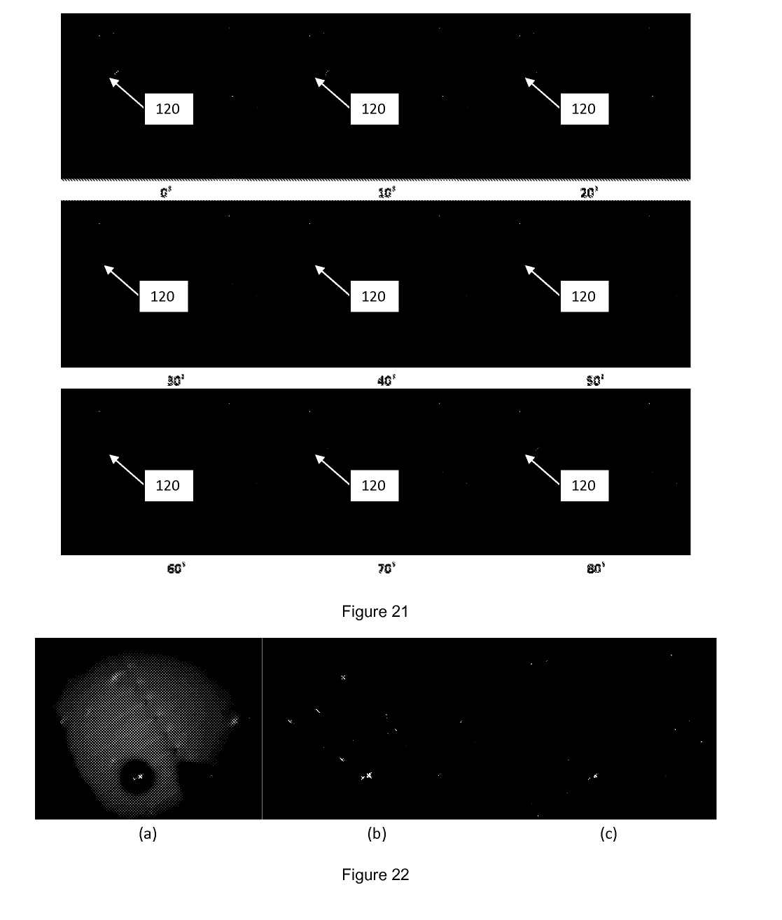

FIG. 21 shows the visibility of the butterfly pattern with different polarization axes of polarizers 66, 64. A most visible butterfly pattern is indicated using arrow 120. The intensity of the most visible butterfly pattern is the maximum at 0 degree and gradually reduced to minimum. The intensity of the butterfly pattern is minimum between 40° and 50° before gradually increasing. The complete cycle will repeat every 90 degree changes in polarization axis. Thus, the maximum intensity will occur on four occasions for a complete rotation of the polarizer 64 and the analyzer 66. This phenomenon is due to the fact that the intensity is at a maximum level when the fast axis or slow axis is aligned at 45° to the polarization axis of analyzer 66.

A comparison of stress pattern images using different light source is shown in FIG. 22. For the same area of inspection, self-scanning light emitting diode (SLED) (FIG. 22(b)) provides the best sensitivity and contrast follow by light emitting diode (LED) (FIG. 22(a)) and halogen (FIG. 22(c)). SLED light source is transmitted with wavelength 1310 nm, while the LED light source is transmitted with wavelength 1200 nm. As shown in FIG. 22 (b), the SLED light source allows stress patterns with lower intensity to be differentiated.

It should be appreciated that there is no necessity to rotate optical elements for rapid real time inspection of the birefringent materials. Rotation of optical elements, for phase shifting can be carried out to separate stress information such as phase retardations and direction of principle stress. The rotation of the optical elements can be carried out either by manual rotation or using an actuator like an electronically controlled motor. It should be appreciated that existing polariscopes like IR-GFP require more complex optical arrangements to incorporate phase shifting techniques to get the stress information.

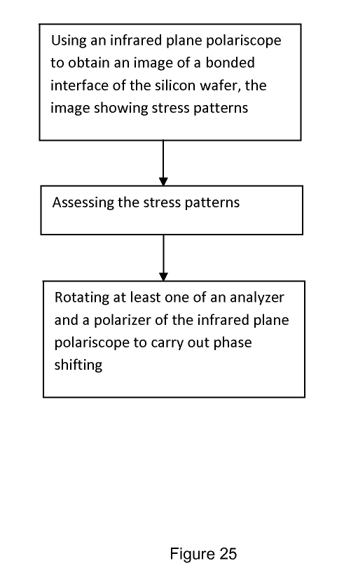

Based on the description of the preceding paragraphs, reference is made to FIG. 25 to provide a process flow which broadly illustrates the method for real time inspection of a silicon wafer of the present invention. The method for real time inspection of a silicon wafer (200) includes the step of using an infrared plane polariscope (as described in preceding paragraphs) to obtain an image of a bonded interface of the silicon wafer (202). Subsequently, the stress patterns are assessed (204), whereby certain conclusions can be drawn from the assessment of the stress patterns as described in preceding paragraphs. Furthermore, the method 200 can include rotating at least one of an analyzer and a polarizer of the infrared plane polariscope to carry out phase shifting (206) so as to obtain further conclusions as described in preceding paragraphs.

The IR-PP 60, 70 as described in the preceding paragraphs allows real time inspection of a bonded quality for silicon wafers. Currently the semiconductor industry, particularly wafer fabs are looking for rapid inspection methods for the wafer bonding process. The IR-PP 60, 70 can be readily integrated into existing production lines such that the advantages as mentioned in the preceding paragraphs can be enjoyed by existing production lines.

Based on the preceding description, it is evident that a system for real time inspection of a silicon wafer(s) can be implemented with the use of the IR-PP 60, 70 (which one depends on composition of the wafer), particularly using the method as described in the preceding paragraphs. It is apparent that the system using IR-PP 60, 70 to obtain the requisite images for real time inspection of a silicon wafer(s) can also be readily integrated into existing production lines.

Whilst there has been described in the foregoing description preferred embodiments of the present invention, it will be understood by those skilled in the technology concerned that many variations or modifications in details of design or construction may be made without departing from the present invention.

1. A method for real time inspection of a silicon wafer, the method including:
using an infrared plane polariscope to obtain an image of a bonded interface of the silicon wafer, the image showing stress patterns; and
assessing the stress patterns,
wherein the stress patterns in a form of at least one butterfly pattern indicates a presence of at least one of: at least one trapped particle, trapped gases and at least one de-bonding region.

2. The method of claim 1, wherein a size of the at least one butterfly pattern is larger than a size of the at least one of: at least one trapped particle, trapped gases and at least one de-bonding region.

3. The method of claim 1, wherein a size of the stress patterns is proportional to a size of the at least one of: at least one trapped particle, trapped gases and at least one de-bonding region.

4. The method of claim 1, further including rotating at least one of an analyzer and a polarizer of the infrared plane polariscope to carry out phase shifting.

5. The method of claim 4, wherein the rotation of the at least one of the analyzer and the polarizer is carried out respectively either by manual rotation or using an actuator.

6. The method of claim 4, wherein the phase shifting is carried out to investigate isoclinics and phase retardation.

7. The method of claim 4, wherein a level of intensity of light emerging from the analyzer correlates to stress generated by the at least one of: at least one trapped particle, trapped gases and a de-bonding region.

8. The method of claim 6, wherein magnitude and direction of stress generated by the at least one of: at least one trapped particle, trapped gases and at least one de-bonding region is obtainable from investigating isoclinics and phase retardation.

9. The method of claim 1, wherein assessing of the stress patterns is carried out using known image processing software and hardware.

10. The method of claim 9, wherein the use of known image processing software and hardware is employed during instances of poor lighting conditions.

11. A system for real time inspection of a silicon wafer using an infrared plane polariscope to obtain an image of a bonded interface of the silicon wafer.
